(19) United States
(12) Patent Application Publication
(10) Pub. No.: US 2026/0359535 A1
(43) Pub. Date: Nov. 12, 2026

(54) SYSTEMS AND METHODS FOR SOLVING IR VIOLATIONS

(71) Applicant: Taiwan Semiconductor Manufacturing Company, Ltd., Hsinchu (TW)

(72) Inventors: Yu-Wen Lin, Hsinchu City (TW); Wei-Chih Hsieh, Hsinchu City (TW); Florentin Dartu, Hsinchu City (TW)

(73) Assignee: Taiwan Semiconductor Manufacturing Company, Ltd., Hsinchu (TW)

(21) Appl. No.: 19/747,719

(22) Filed: Jul. 20, 2026

Related U.S. Application Data
(63) Continuation of application No. 18/508,769, filed on Nov. 14, 2023.

(51) Int. Cl. G06F 30/3315; G06F 119/12

(52) U.S. Cl. CPC G06F 30/3315; G06F 2119/12

(57) ABSTRACT

A method for designing an integrated circuit comprises performing a voltage (IR) drop analysis on a first circuit component disposed along a plurality of timing paths; categorizing a plurality of output loads based on a timing criticality of respective timing paths associated with the plurality of output loads; and adding a second circuit component to drive a subset of the plurality of output loads that are categorized as non-timing-critical, while keeping the first circuit component to drive a remaining subset of the plurality of output loads that are categorized as timing-critical. The first circuit component may have the plurality of output loads.

### CROSS-REFERENCE TO RELATED APPLICATION

This application is a continuation of U.S. Utility application Ser. No. 18/508,769, filed Nov. 14, 2023, the entire disclosure of which is incorporated herein by reference for all purposes.

### BACKGROUND

In a design of an integrated circuit, various cells having predetermined functions are used. Pre-designed layouts of standard cells or memory cells are stored in cell libraries. During the integrated circuit design process, the pre-designed layouts of the standard cells are retrieved from the cell libraries and placed at selected locations in an integrated circuit layout. Routing is then performed to connect components of the standard cells with each other using interconnect lines. Because of the complexity of various designs, an electronic design automation (EDA) tool is used to simulate and verify the integrated circuits at various levels of abstraction under the direction of a designer, in some instances. The EDA tool performs various tasks, such as design rule checking, layout versus schematic checking, layout parasitic extraction and resistance-capacitance (RC) extraction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an example block diagram of an integrated circuit, in accordance with some embodiments of the present disclosure.

FIG. 2 is a flow chart of a method for designing an integrated circuit, in accordance with some embodiments of the present disclosure.

FIG. 3 is an example block diagram of an integrated circuit, in accordance with some embodiments of the present disclosure.

FIG. 4 is an example block diagram of an integrated circuit, in accordance with some embodiments of the present disclosure.

FIG. 5 is an example block diagram of an integrated circuit, in accordance with some embodiments of the present disclosure.

FIG. 6 shows demonstrations with splitting load, in accordance with some embodiments of the present disclosure.

FIG. 7 is a flowchart illustrating a design flow for an integrated circuit, in accordance with some embodiments of the present disclosure.

FIG. 8 is a functional block diagram of an integrated circuit designing system, in accordance with one or more embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the realm of integrated circuit design, mitigating the impact of IR drop on instances has long been a focal point for optimizing performance and power consumption. Some strategies such as down-sizing cells and down-swapping (threshold voltage (VT) devices have been employed to tackle IR drop issues. However, the efficacy of these strategies is significantly contingent upon the extent of timing margin available along critical paths. As these paths approach their limits in terms of timing margin, the viability of existing approaches diminishes.

A critical limitation emerges when the timing margin is depleted, leading to a roadblock in the effectiveness of down-sizing and VT device swapping as viable solutions. Instances grappling with IR violations cease to be amenable to these conventional strategies once timing margin resources have been exhausted. This gap underscores the need for a fresh perspective that not only addresses IR drop but also recognizes the interconnectedness of timing margins in the optimization process. This context elucidates the challenges posed by existing strategies and highlights the exigency for an innovative approach that transcends the constraints imposed by diminishing timing margins.

In an integrated circuit design, achieving optimal performance while minimizing power consumption remains a challenging endeavor. To address this challenge, the present disclosure provides a groundbreaking voltage (IR) optimization strategy which creates additional timing margin by splitting loads for extra IR drop reduction. The split load strategy not only focuses on IR reduction (IR-aware) but also takes timing (timing-aware) considerations into account, resulting in improved overall design efficiency. One of the key objectives of this strategy is to minimize the need for manual intervention in identifying useful margins throughout the design process. The split load procedure, which forms the core of this approach, is designed to be both fast and lightweight, further enhancing its practicality and feasibility for implementation in a semiconductor manufacturing process.

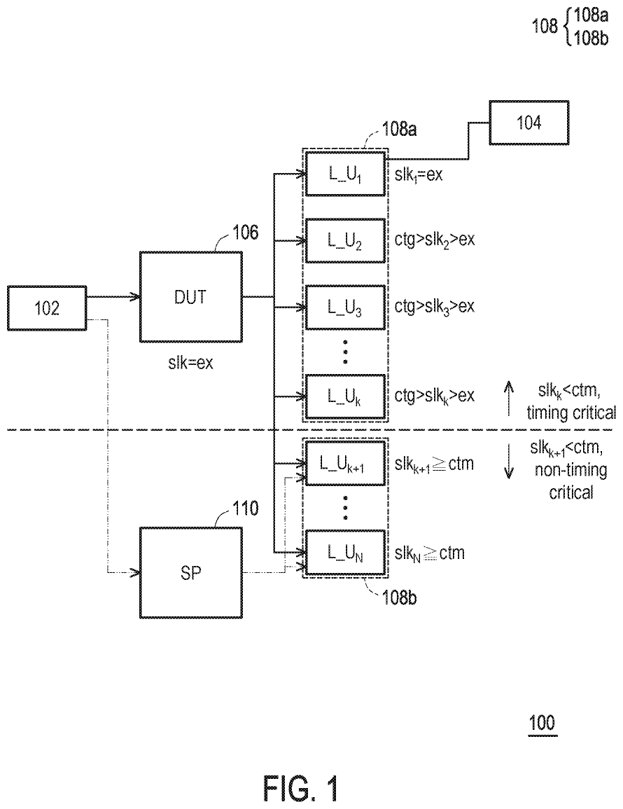

FIG. 1 is an example block diagram of an integrated circuit 100, in accordance with some embodiments of the present disclosure. The integrated circuit 100 may include a first storage node 102, a second storage node 104, a first circuit component 106, a plurality of timing paths 108, and a second circuit component 110. The first circuit component 106 can be disposed along the plurality of timing paths 108 that each extend from the first storage node 102 and to the second storage node 104 and are each associated with a timing margin (e.g., a timing slack).

The first storage node 102 and the second storage node 104 may each include, but is not limited to, a flip-flop circuit, a latch circuit, a driver circuit, or a combinational logic circuit. The first circuit component 106 can be a standard cell. A standard cell may include at least one functional cell and at least one non-functional cell (e.g., an engineering change order (ECO) cell), for various applications. A functional cell is designed to perform a specific function such as a logic function or a storage function. An ECO cell is designed without a specific function, but is programmable to provide a specific function. During an integrated circuit design, designed layouts of one or more functional cells are read out from cell libraries and are placed into an initial layout.

The first circuit component 106 may present a voltage (IR) drop. When current flows through the first circuit component 106, a portion of the applied voltage may be dropped in the first circuit component 106 as per the Ohm's law. The amount of voltage drop can be V=I*R, which is called an IR drop. An IR drop analysis can be a process used in semiconductor design to assess voltage drops across circuit components due to current flow. Excessive IR drop can affect performance and reliability. It may involve simulating and analyzing voltage drops using specialized software and making design adjustments to mitigate issues. To mitigate IR drop and improve IC performance, strategies including cell down-sizing and device swapping can be utilized. In some embodiments, the driving current capability of the first circuit component 106 can be determined based on a threshold voltage (VT) of one or more transistors within the circuit component (e.g., 106 or 110). In some embodiments, the threshold voltage VT can be categorized as at least a high threshold voltage (HVT), a low threshold voltage (LVT) or a standard threshold voltage (SVT). In some embodiments, HVT can be greater than at least LVT or SVT. In some embodiments, SVT can be greater than LVT. For example, when the IR drop of the first circuit component 106 (e.g., the device under testing (DUT) has an IR drop of about 18%) is equal to or greater than an IR drop threshold (e.g., about 10%) through at least an IR drop analysis, it can be an IR violated instance which has many fanout load. The first circuit component 106 can be downsized or swapped from a first cell to a second cell. The reduction in IR drop of the first circuit component (106) results in a decrease from about 18% to about 9%. However, it may also reduce the remaining timing slack on paths from about 25 picoseconds (ps) to about 3 ps. The reduced remaining time slack may lead to exhausted/depleted slack.

Static timing analysis is a method of validating the timing performance of a design by checking all possible timing paths for timing violations under worst case conditions. Static timing analysis may be performed by various EDA software, such as but not limited to DESIGN COMPILER, ENCOUNTER, IC COMPILER, or PRIME TIME, at different design stages as described above. For example, each timing path starts from a first storage node 102 (e.g., flip-flop 1 (FF1)) and ends at a second storage node 104 (e.g., flip-flop 2 (FF2)) of the integrated circuit 100. For example, by traversing all timing paths/nodes (L_U₁, L_U₂, L_U₃ . . . , L_Uₖ, . . . , L_U_{N}) from flip-flop 1 (FF1) 102 to flip-flop 2 (FF2) 104, multiple timing paths may be identified. In some embodiments, L_U_{N} can be a load instance of the DUT with index N, sorted by timing margin (sometimes referred to as “slack” or “slk”), where “slk_{N}” can be a timing margin (e.g., slack) of load instance L_U_{N}, “ex” can be an exhausted timing margin (e.g., slack) of the DUT dominated by L_U_{N}, and “ctm” can be a critical timing margin.

The plurality of timing paths 108 may include a first subset of timing paths 108a and a second subset of timing paths 108b. The plurality of timing paths 108 may include one or more nodes (e.g., L_U₁, L_U₂, L_U₃, . . . , L_Uₖ, . . . , L_U_{N}). Each node may be any suitable combinational logic of the integrated circuit such as AND, OR, NOR, etc. The slack associated with each timing path can be the difference between the required time and the arrival time and can be determined by the static timing analysis as known in the art. All timing paths that have the value of slack less than a predetermined value may be considered as timing critical paths in the static timing analysis. The value of slack may be in time units such as picosecond (ps). For example, if the predetermined value is about 0 ps, then all timing paths that have negative slacks are considered to be timing critical paths. A positive slack value at a flip-flop implies that the arrival time at that flip-flop may be increased by its value without affecting the overall performance of the circuit. Conversely, negative slack implies that a timing path is too slow, and the timing path must be sped up (or the reference signal delayed) if the whole circuit is to work at the desired speed. Accordingly, timing critical paths in this example are those timing paths that do not meet the timing requirement.

In order to assure that the designed integrated circuit meets the specific speed requirement, timing performance of the designed integrated circuit is validated at the timing analysis stage by checking all possible paths for timing violations (i.e., timing constraints) under worst case conditions. If the timing analysis stage determines that the integrated circuit cannot operate at the desired clock frequency range, a split-load process is necessary to modify the design through one or more IR optimization and timing optimization strategies. The split-load process may include, for example, splitting the plurality of timing paths/nodes into a first subset of timing paths 108a and a second subset of timing paths 108b, based on a timing margin threshold (e.g., ctm). The value of timing margin may be in time units such as picosecond (ps). In some embodiments, when the first circuit component 106 may present an IR violation (e.g., IR drop=about 14.0%), the plurality of timing paths 108 can be split based on a critical timing margin (ctm) of about 10 ps. The timing paths with a timing margin equal to or less than about 10 ps (e.g., timing critical paths) can be grouped into the first subset of timing paths 108a, while those with a timing margin exceeding about 10 ps (e.g., non-timing critical paths) can be grouped into the second subset of timing paths 108b.

The key concept of the split-load methodology revolves around generating extra margins within a design by addressing slack-exhausted paths. The split-load process may involve identifying instances where IR violations occur due to numerous fanout loads. These loads are then categorized based on their timing criticality. For those loads that are not considered critical in terms of timing, load splitting techniques are applied as a strategy to optimize and improve the overall performance of the design. The split-load methodology may be applied to improve the timing performance and IR violations at a clock-tree synthesis (CTS) stage, a routing stage, and/or any other suitable stage in the design flow.

In certain embodiments, the second circuit component 110 can be identical to the first circuit component 106. The second circuit component 110 (e.g., SP) can be a duplicated instance which splits loads from the first circuit component 106 (e.g., DUT). In some embodiments, the second circuit component 110 can be disposed along the second subset of timing paths 108b, while keeping the first circuit component 106 disposed along the first subset of timing paths 108a.

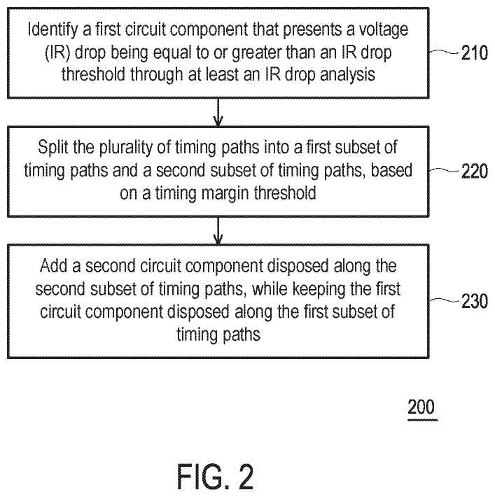

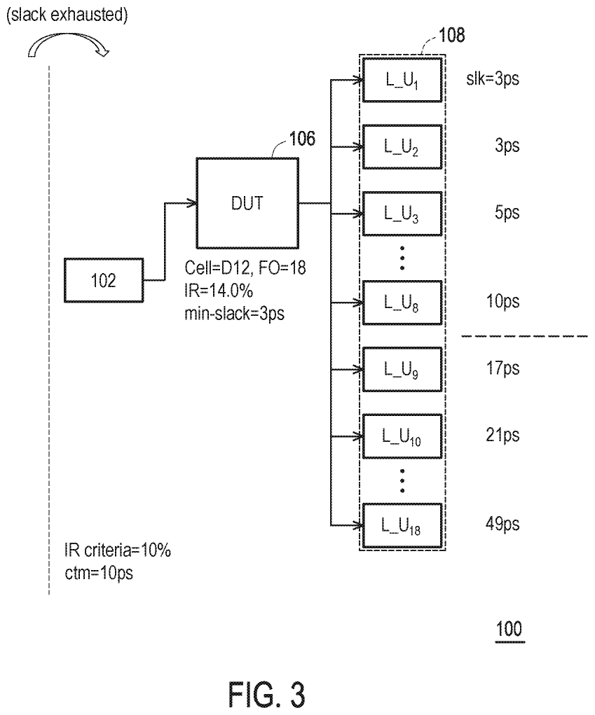

FIG. 2 is a flow chart of a method 200 for designing an integrated circuit 100, in accordance with some embodiments of the present disclosure. FIGS. 3-5 illustrate an example block diagram of an integrated circuit 100 corresponding to the method 200 of FIG. 2 for solving IR violations, in accordance with some embodiments of the present disclosure. One of ordinary skill in the art would understand that additional operations are able to be performed before, during, and/or after method 200 depicted in FIG. 2, in some embodiments. In some embodiments, a place and route electronic design automation (EDA) tool can be used to design the initial layout to be used to form one or more circuit patterns of a semiconductor device.

As shown in FIG. 2 and FIG. 3, the method 200 may include operation 210 in which a first circuit component 106 that presents a voltage (IR) drop being equal to or greater than an IR drop threshold can be identified. A hardware computer (e.g., an EDA tool) may identify a first circuit component 106 with an IR violation through at least an IR drop analysis. For example, an IR drop threshold is set at about 10% and a first circuit component 106 exhibits/presents an IR drop of about 14.0%, the first circuit component 106 can be identified as an IR violated instance. The min-slack of the first circuit component 106 can be about 3 ps, indicating that a timing path within it is too slow. To achieve the desired circuit speed, the timing path must be sped up (or the reference signal delayed) to create additional timing margins. In some embodiments, the first circuit component 106 can be disposed along a plurality of timing paths 108 that each extend from a first storage node 102 and to a second storage node 104. The first 102 and second storage nodes 104 may each include a flip-flop circuit or a latch circuit. Each of the plurality of timing paths 108 associated with a timing margin (e.g., slack). For example, the timing margin of L_U₁ can be 3 about ps. The timing margin of L_U₂ can be about 3 ps. The timing margin of L_U₃ can be about 5 ps. The timing margin of L_U₈ can be about 10 ps. The timing margin of L_U₉ can be about 17 ps. The timing margin of L_U₁₀ can be about 21 ps. The timing margin of L_U₁₈ can be about 49 ps. In some embodiments, the plurality of timing paths can be arranged from a lowest timing margin (e.g., L_U₁ with about 3 ps) to a highest timing margin (e.g., L_U₁₈ with about 49 ps).

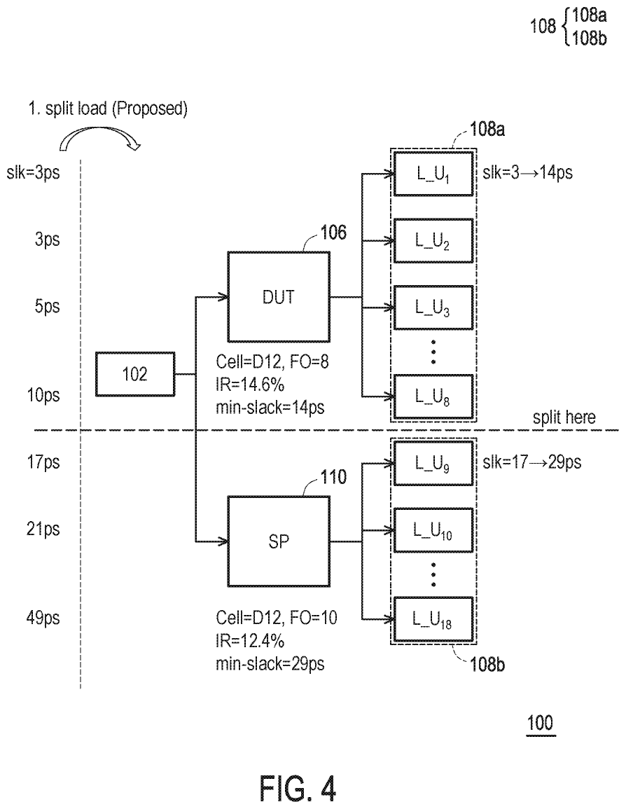

As shown in FIG. 2 and FIG. 4, the method 200 continues with operation 220 in which the plurality of timing paths 108 can be split into a first subset of timing paths 108a and a second subset of timing paths 108b, based on a timing margin threshold. In some embodiments, the hardware computer may compare the timing margin of each of the plurality of timing paths 108 with a timing margin threshold (e.g., about 10 ps). In response to determining that the timing margin of a first one (e.g., L_U₈) of the timing paths is less than the timing margin threshold (e.g., about 10 ps), the first timing path (e.g., L_U₁-L_U₈) can be grouped into the first subset of timing paths 108a. In response to determining that the timing margin of a second one (e.g., L_U₉-L_U₁₈) of the timing paths is equal to or greater than the timing margin threshold (e.g., about 10 ps), the second timing path 108b can be grouped into the second subset of timing paths 108b.

In the context of the split-load methodology, this operation 220 demonstrates a process of relaxing timing margins. Timing-critical components of the device under test (DUT) 106 and their loads (e.g., L_U₁ to L_U₈) are kept in their original positions with their routing preserved. Meanwhile, non-critical loads (e.g., L_U₉ to L_U₁₈) are rerouted to newly added second circuit component 110 (e.g., SP) instances. After splitting the loads, the IR drop of the first circuit component 106 becomes about 14.6% and the min-slack of the first circuit component 106 improves to about 14 ps, indicating that additional timing margin are created.

As shown in FIG. 2 and FIG. 4, the method 200 continues with operation 230 in which a second circuit component 110 (e.g., SP) can be added disposed along the second subset of timing paths 108b, while keeping the first circuit component 106 disposed along the first subset of timing paths 108a. In some embodiments, the second circuit component 110 can be identical to the first circuit component 106. The IR drop of the second circuit component 110 is about 12.4% and the min-slack of the second circuit component 110 is about 29 ps. This approach allows for more flexible timing adjustments while maintaining critical timing integrity.

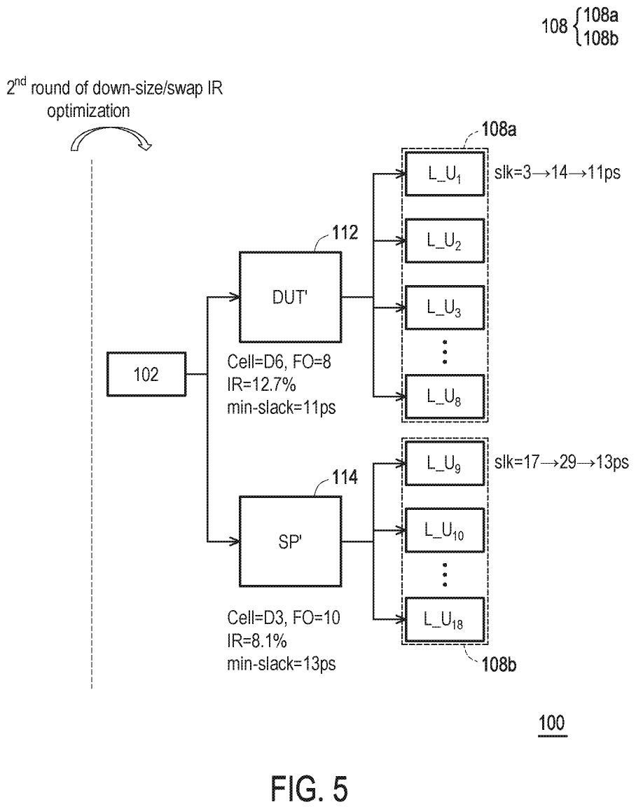

Following the acquisition of timing margins from both the in-placed DUT and the split SP components, a second round of downsizing and IR optimization becomes effective. As shown in FIG. 5, the method 200 may continue with additional operation in which the first circuit component 106 can be replaced with a third circuit component 112 (e.g., DUT′). The third circuit component 112 may present an updated IR drop (e.g., about 12.7%). The min-slack of the third circuit component 112 can be about 11 ps. In some embodiments, the third circuit component 112 (e.g., Cell=D6) may have lower driving power than the first circuit component 106 (e.g., Cell=D12). The second circuit component 110 can be replaced with a fourth circuit component 114 (e.g., SP′). The fourth circuit component 114 may present an updated IR drop (e.g., about 8.1%) being less than the IR drop threshold (e.g., about 10%). The min-slack of the fourth circuit component 114 can be about 13 ps. In some embodiments, the fourth circuit component 114 (e.g., Cell=D3) may have lower driving power than the second circuit component 110 (e.g., Cell=D12).

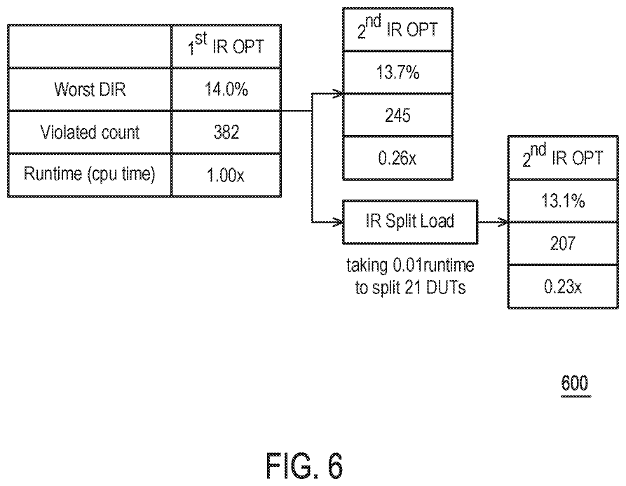

FIG. 6 shows demonstrations 600 with splitting load, in accordance with some embodiments of the present disclosure. In a design comprising a total of 190,000 instances, the split-load methodology proves its efficiency with several notable advantages. Specifically, the split-load process takes up only 0.01 times the runtime for processing, demonstrating its swift execution. Out of the 382 IR violated device under tests (DUTs) within the design, load splitting is applied to only 21 DUTs. The approach of the present disclosure results in about 16% additional reduction in the count of violated DUTs compared to the optimization process without load splitting. These findings underline the effectiveness of load splitting in optimizing the design's performance and ensuring compliance with timing constraints.

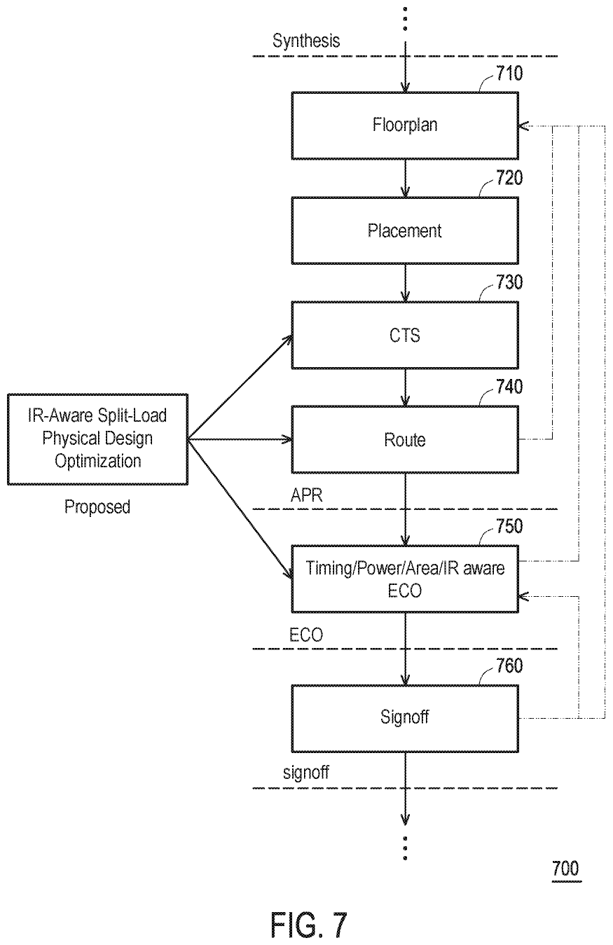

FIG. 7 is a functional flow chart 700 of at least a portion of an IC design and manufacturing flow 200, in accordance with some embodiments. The design and manufacturing flow 700 utilizes one or more electronic design automation (EDA) tools for generating, optimizing and/or verifying a design of an IC before manufacturing the IC. The EDA tools, in some embodiments, are one or more sets of executable instructions for execution by a processor or controller or a programmed computer to perform the indicated functionality. In at least one embodiment, the IC design and manufacturing flow 700 is performed by a design house of an IC manufacturing system discussed herein with respect to FIG. 7.

At a beginning stage, a design of an IC is provided by a circuit designer. In some embodiments, the design of the IC comprises an IC schematic, i.e., an electrical diagram, of the IC. In some embodiments, the schematic is generated or provided in the form of a schematic netlist, such as a Simulation Program with Integrated Circuit Emphasis (SPICE) netlist. Other data formats for describing the design are usable in some embodiments. In some embodiments, a pre-layout simulation is performed on the design to determine whether the design meets a predetermined specification. When the design does not meet the predetermined specification, the IC is redesigned. In at least one embodiment, a pre-layout simulation is omitted from FIG. 7. In at least one embodiment, method 700 further includes a pre-layout simulation performed.

At Automatic Placement and Routing (APR) operation 710-740, a layout diagram of the IC is generated based on the IC schematic. The IC layout diagram comprises the physical positions of various circuit elements of the IC as well as the physical positions of various nets interconnecting the circuit elements. For example, the IC layout diagram is generated in the form of a Graphic Design System (GDS) or GDSII file. Other data formats for describing the design of the IC are within the scope of various embodiments. In the example configuration in FIG. 7, the IC layout diagram is generated by an EDA tool, such as an APR tool. The APR tool receives the design of the IC in the form of a netlist as described herein. The APR tool performs floor planning to identify circuit elements, which are to be electrically connected to each other and which are to be placed in close proximity to each other, for reducing the area of the IC and/or reducing time delays of signals travelling over the interconnections or nets connecting the electrically connected circuit elements. In some embodiments, the APR tool performs partitioning to divide the design of the IC into a plurality of blocks or groups, such as clock and logic groups. In the example configuration in FIG. 7, the APR tool performs one or more of a power planning operation 710, a cell placement operation 720, a clock tree synthesis (CTS) operation 730 or a routing operation 740.

At power planning operation 710, the APR tool performs power planning, based on the partitioning and/or the floor planning of the IC design, to generate a power grid structure which includes several conductive layers, such as metal layers. In some embodiments, one metal layer of the metal layers includes power lines or power rails extending in one direction, e.g., horizontally in a plan view. In some embodiments, another metal layer of the metal layers includes power lines or power rails extending in an orthogonal direction, e.g., vertically in a plan view.

At cell placement operation 720, the APR tool performs cell placement. For example, standard cells (also referred to herein as “cells”) configured to provide pre-defined functions and having pre-designed layout diagrams are stored in one or more cell libraries. The APR tool accesses various cells from one or more cell libraries, and places the cells in an abutting manner to generate an IC layout diagram corresponding to the IC schematic.

The generated IC layout diagram includes the power grid structure and a plurality of cells, each cell including one or more circuit elements and/or one or more nets. In some embodiments, each cell includes one or more flip-flops or one or more multi-bit flip-flops. In some embodiments, a cell includes a logic gate cell. In some embodiments, a logic gate cell includes an AND, OR, NAND, NOR, XOR, INV, AND-OR-Invert (AOI), OR-AND-Invert (OAI), MUX, Flip-flop, BUFF, Latch, delay, clock cells, or the like. In some embodiments, a cell includes a memory cell. In some embodiments, a memory cell includes a static random access memory (SRAM), a dynamic RAM (DRAM), a resistive RAM (RRAM), a magnetoresistive RAM (MRAM), a read only memory (ROM), or the like. In some embodiments, a circuit element is an active element or a passive element. Examples of active elements include, but are not limited to, transistors and diodes. Examples of transistors include, but are not limited to, metal oxide semiconductor field effect transistors (MOSFET), complementary metal oxide semiconductor (CMOS) transistors, bipolar junction transistors (BJT), high voltage transistors, high frequency transistors, p-channel and/or n-channel field effect transistors (PFETs/NFETs), or the like, FinFETs, planar MOS transistors with raised source/drains, or the like. Examples of passive elements include, but are not limited to, capacitors, inductors, fuses, and resistors. Examples of nets include, but are not limited to, vias, conductive pads, conductive traces, and conductive redistribution layers, or the like.

At clock tree synthesis (CTS) operation 730, the APR tool performs CTS to minimize skew and/or delays potentially present due to the placement of circuit elements in the IC layout diagram. The CTS includes an optimization process to ensure that signals are transmitted and/or arrived at appropriate timings. For example, during the optimization process within the CTS, one or more buffers are inserted into the IC layout diagram to add and/or remove slack (timing for signal arrival) to achieve a desired timing. In some embodiments, operation 730 includes performing a timing analysis of one or more critical paths that include one or more multi-bit flip-flops to determine timing violations in the one or more critical paths. The described CTS of operation 730 is an example. Other arrangements or operations are within the scope of various embodiments. For example, in one or more embodiments, one or more of the described operations are repeated or omitted.

At routing operation 740, the APR tool performs routing to route various nets interconnecting the placed circuit elements. The routing is performed to ensure that the routed interconnections or nets satisfy a set of constraints. For example, routing operation 740 includes global routing, track assignment and detailed routing. During the global routing, routing resources used for interconnections or nets are allocated. For example, the routing area is divided into a number of sub-areas, pins of the placed circuit elements are mapped to the sub-areas, and nets are constructed as sets of sub-areas in which interconnections are physically routable. During the track assignment, the APR tool assigns interconnections or nets to corresponding conductive layers of the IC layout diagram. During the detailed routing, the APR tool routes interconnections or nets in the assigned conductive layers and within the global routing resources. For example, detailed, physical interconnections are generated within the corresponding sets of sub-areas defined at the global routing and in the conductive layers defined at the track assignment. After routing operation 740, the APR tool outputs the IC layout diagram including the power grid structure, placed circuit elements and routed nets. The described APR tool is an example. Other arrangements are within the scope of various embodiments. For example, in one or more embodiments, one or more of the described operations are omitted.

At timing/power/area/IR aware ECO operation 750, at least one ECO cell can be programmable to provide a specific function. Standard cells may include functional cells and engineering change order (ECO) cells. A functional cell is pre-designed to have a specific function, e.g., a logic function. An ECO cell is pre-designed without a specific function, but is programmable to provide a specific function. To design an IC, the pre-designed layouts of one or more functional cells are read out from the standard cell libraries and placed into an initial IC layout. Routing is performed to connect the functional cells using one or more metal layers. The IC layout also includes one or more ECO cells which are not connected to the functional cells. When the IC layout is to be revised, one or more ECO cells are programmed to provide an intended function and routed to the functional cells. The programming of the ECO cells involves modifications in several layers of the IC layout and/or masks for manufacturing the IC.

In some embodiments, an IR drop analysis and/or a timing analysis can be applied to any operations of the design and manufacturing flow 700. Once an IR violated instance is identified, an IR-aware split load physical optimization can be applied to those operations (e.g., operations 730, 740, or 750). Hence, one or more embodiments of the present disclosure are designed to optimize IR while addressing timing violations concurrently. This results in an integrated circuit (IC) that consumes less power and reduces the need for manual interventions. Moreover, in certain embodiments, these disclosures are structured to optimize IR and simultaneously generate additional timing margins, streamlining the design and manufacturing flow 700. This approach involves fewer steps compared to other methods that involve downsizing and down-swapping threshold voltage (VT) devices, particularly those that do not address one or more IR violations.

At sign-off operation 760, one or more physical and/or timing verifications are performed. For example, sign-off operation 760 includes one or more of a resistance and capacitance (RC) extraction, a layout-versus-schematic (LVS) check, a design rule check (DRC) or a timing sign-off check (also referred to as a post-layout simulation). In some embodiments, other verification processes are performed.

In some embodiments, an RC extraction is performed, e.g., by an EDA tool, to determine parasitic parameters, e.g., parasitic resistance and parasitic capacitance, of components in the IC layout diagram for timing simulations in a subsequent operation. In some embodiments, an LVS check is performed to ensure that the generated IC layout diagram corresponds to the design of the IC. Specifically, an LVS checking tool, i.e., an EDA tool, recognizes electrical components as well as connections in the space between the patterns of the generated IC layout diagram. The LVS checking tool then generates a layout netlist representing the recognized electrical components and connections. The layout netlist generated from the IC layout diagram is compared, by the LVS checking tool, with the schematic netlist of the design of the IC. If the two netlists match within a matching tolerance, the LVS check is passed. Otherwise, correction is made to at least one of the IC layout diagram or the design of the IC by returning the process to IC design operation and/or APR operation.

In some embodiments, a DRC is performed, e.g., by an EDA tool, to ensure that the IC layout diagram satisfies certain manufacturing design rules, i.e., to ensure manufacturability of the IC. If one or more design rules is/are violated, correction is made to at least one of the IC layout diagram or the design of the IC by returning the process to IC design operation and/or APR operation. Examples of design rules include, but are not limited to, a width rule which specifies a minimum width of a pattern in the IC layout diagram, a spacing rule which specifies a minimum spacing between adjacent patterns in the IC layout diagram, an area rule which specifies a minimum area of a pattern in the IC layout diagram, or the like.

In some embodiments, a timing sign-off check (post-layout simulation) is performed, e.g., by an EDA tool, to determine, taking the extracted parasitic parameters into account, whether the IC layout diagram meets a predetermined specification of one or more timing requirements. If the simulation indicates that the IC layout diagram does not meet the predetermined specification, e.g., if the parasitic parameters cause undesirable delays, correction is made to at least one of the IC layout diagram or the design of the IC by returning the process to IC design operation and/or APR operation. Otherwise, the IC layout diagram is passed to manufacture or additional verification processes.

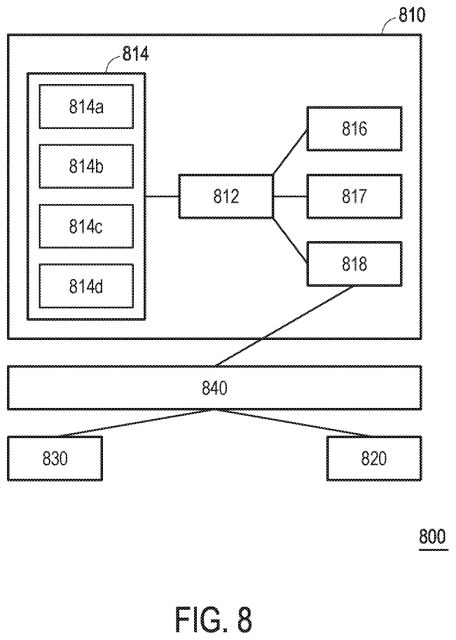

FIG. 8 is a functional block diagram of an integrated circuit designing system 800, in accordance with one or more embodiments of the present disclosure. Integrated circuit designing system 800 includes a first computer system 810, a second computer system 820, a networked storage device 830, and a network 840 connecting the first computer system 810, the second computer system 820, and the networked storage device 830. In some embodiments, one or more of second computer system 820, networked storage device 830, and network 840 can be omitted.

The first computer system 810 includes a hardware processor 812 communicatively coupled with a non-transitory, computer readable storage medium 814 encoded with, i.e., storing, a generated integrated layout 814a, a circuit design 814b, and a computer program code 814c, i.e., a set of executable instructions. Hardware processor 812 is communicatively coupled to computer readable storage medium 814. Hardware processor 812 is configured to execute a set of instructions 814c encoded in computer readable storage medium 814 in order to cause first computer system 810 to be usable as a placing and routing tool for performing a portion or all of operations 202-206 as depicted in FIG. s. In some embodiments, hardware processor 812 is configured to execute set of instructions 814c for generating an integrated circuit layout based on the layout of the cell, the IR drop criteria, and the timing margin threshold corresponding to a predetermined semiconductor manufacturing process. In some embodiments, hardware processor 812 is a central processing unit (CPU), a multi-processor, a distributed processing system, an application specific integrated circuit (ASIC), and/or a suitable processing unit.

In some embodiments, computer readable storage medium 814 is an electronic, magnetic, optical, electromagnetic, infrared, and/or a semiconductor system (or apparatus or device). In some embodiments, computer readable storage medium 814 includes a semiconductor or solid-state memory, a magnetic tape, a removable computer diskette, a random access memory (RAM), a read-only memory (ROM), a rigid magnetic disk, and/or an optical disk. In some embodiments using optical disks, computer readable storage medium 814 includes a compact disk-read only memory (CD-ROM), a compact disk-read/write (CD-R/W), and/or a digital video disc (DVD).

In some embodiments, storage medium 814 stores computer program code 814c configured to cause first computer system 810 to perform method 200 as depicted in FIGS. 3-7. In some embodiments, storage medium 814 also stores information needed for performing method 200 or generated during performing method 200.

The first computer system 810 may include an input/output interface 816 and a display unit 817. The input/output interface 816 can be coupled to hardware processor 812 and may allow a circuit designer to manipulate first computer system 810 in order to perform methods 200. In at least some embodiments, display unit 817 may display the status of operation of methods 200 in a real-time manner and preferably provides a Graphical User Interface (GUI). In some embodiments, the input/output interface 816 and the display unit 817 may allow an operator to operate first computer system 810 in an interactive manner.

In some embodiments, the first computer system 810 may further include a network interface 818 coupled to hardware processor 812. Network interface 818 may allow the first computer system 810 to communicate with network 840, to which one or more other computer systems 820 and networked storage device 830 are connected. The network interface 818 includes wireless network interfaces such as BLUETOOTH, WIFI, WIMAX, GPRS, or WCDMA; or wired network interface such as ETHERNET, USB, or IEEE-1394. In some embodiments, method 200 is implemented in two or more computer systems 810 and 820 and/or networked storage device 830, and information such as integrated circuit layout 814a, circuit design 814b, computer program code 814c and cell library 814d can be exchanged between different computer systems 810 and 820 and/or networked storage device 830 via network 840.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for designing an integrated circuit, comprising:
performing a voltage (IR) drop analysis on a first circuit component disposed along a plurality of timing paths, wherein the first circuit component has a plurality of output loads;
categorizing the plurality of output loads based on a timing criticality of respective timing paths associated with the plurality of output loads; and
adding a second circuit component to drive a subset of the plurality of output loads that are categorized as non-timing-critical, while keeping the first circuit component to drive a remaining subset of the plurality of output loads that are categorized as timing-critical.

2. The method of claim 1, comprising:
identifying the first circuit component that presents the IR drop being equal to or greater than an IR drop threshold through the IR drop analysis, wherein the first circuit component is disposed along a plurality of timing paths that each extend from a first storage node and to a second storage node and are each associated with a timing margin; and
splitting the plurality of timing paths into a first subset of timing paths and a second subset of timing paths, based on a timing margin threshold.

3. The method of claim 2, further comprising:
comparing the timing margin of each of the plurality of timing paths with the timing margin threshold.

4. The method of claim 3, further comprising:
in response to determining that the timing margin of a first one of the timing paths is less than the timing margin threshold, grouping the first timing path into the first subset of timing paths.

5. The method of claim 3, further comprising:
in response to determining that the timing margin of a second one of the timing paths is equal to or greater than the timing margin threshold, grouping the second timing path into the second subset of timing paths.

6. The method of claim 1, wherein the second circuit component is identical to the first circuit component.

7. The method of claim 6, further comprising:
replacing the first circuit component with a third circuit component presenting an updated IR drop being less than an IR drop threshold; and
replacing the second circuit component with a fourth circuit component presenting the updated IR drop.

8. The method of claim 7, wherein the third circuit component has lower driving power than the first circuit component.

9. The method of claim 7, wherein the fourth circuit component has lower driving power than the second circuit component.

10. The method of claim 2, further comprising:
arranging the plurality of timing paths from a lowest timing margin to a highest timing margin.

11. A system for designing an integrated circuit, comprising:
a non-transitory storage medium encoded with a set of instructions; and
a hardware processor communicatively coupled with the non-transitory storage medium and configured to execute the set of instructions, the set of instructions being configured to cause the hardware processor to:
perform a voltage (IR) drop analysis on a first circuit component disposed along a plurality of timing paths, wherein the first circuit component has a plurality of output loads;
categorize the plurality of output loads based on a timing criticality of respective timing paths associated with the plurality of output loads; and
add a second circuit component to drive a subset of the plurality of output loads that are categorized as non-timing-critical, while keeping the first circuit component to drive a remaining subset of the plurality of output loads that are categorized as timing-critical.

12. The system of claim 11, wherein the set of instructions is configured to further cause the hardware processor to:
identify the first circuit component that presents the IR drop being equal to or greater than an IR drop threshold through the IR drop analysis, wherein the first circuit component is disposed along a plurality of timing paths that each extend from a first storage node and to a second storage node and are each associated with a timing margin; and
split the plurality of timing paths into a first subset of timing paths and a second subset of timing paths, based on a timing margin threshold.

13. The system of claim 12, wherein the set of instructions is configured to further cause the hardware processor to:
compare the timing margin of each of the plurality of timing paths with the timing margin threshold.

14. The system of claim 13, wherein the set of instructions is configured to further cause the hardware processor to:
in response to determining that the timing margin of a first one of the timing paths is less than the timing margin threshold, group the first timing path into the first subset of timing paths.

15. The system of claim 13, wherein the set of instructions is configured to further cause the hardware processor to:
in response to determining that the timing margin of a second one of the timing paths is equal to or greater than the timing margin threshold, group the second timing path into the second subset of timing paths.

16. The system of claim 11, wherein the second circuit component is identical to the first circuit component.

17. The system of claim 16, wherein the set of instructions is configured to further cause the hardware processor to:
replace the first circuit component with a third circuit component presenting an updated IR drop being less than an IR drop threshold; and
replace the second circuit component with a fourth circuit component presenting the updated IR drop.

18. The system of claim 12, wherein the set of instructions is configured to further cause the hardware processor to:
arrange the plurality of timing paths from a lowest timing margin to a highest timing margin.

19. A computer program code stored on a non-transitory computer-readable medium for designing an integrated circuit, the computer program code being configured to cause a system having at least one processor to execute:
performing a voltage (IR) drop analysis on a first circuit component disposed along a plurality of timing paths, wherein the first circuit component has a plurality of output loads;
categorizing the plurality of output loads based on a timing criticality of respective timing paths associated with the plurality of output loads; and
adding a second circuit component to drive a subset of the plurality of output loads that are categorized as non-timing-critical, while keeping the first circuit component to drive a remaining subset of the plurality of output loads that are categorized as timing-critical.

20. The computer program code of claim 19, wherein the computer program code is further configured to cause the system having at least one processor to execute:
identifying the first circuit component that presents the IR drop being equal to or greater than an IR drop threshold through at least an IR drop analysis, wherein the first circuit component is disposed along a plurality of timing paths that each extend from a first storage node and to a second storage node and are each associated with a timing margin; and
splitting the plurality of timing paths into a first subset of timing paths and a second subset of timing paths, based on a timing margin threshold.
